(19) United States
(12) Patent Application Publication
(10) Pub. No.: US 2026/0041943 A1
(43) Pub. Date: Feb. 12, 2026

(54) Lumbar Adjustment System

(71) Applicant: MSA (Suzhou) Safety Equipment R&D Co., Ltd., Jiangsu (CN)

(72) Inventors: LongTeng YU, Jiangsu (CN); Lida ZHU, Jiangsu (CN); Ruitong YAN, Jiangsu (CN); Haifeng YAO, Jiangsu (CN)

(21) Appl. No.: 19/100,611

(22) PCT Filed: Aug. 4, 2023
(86) PCT No.: PCT/CN2023/111291

§ 371 Date: Feb. 3, 2025

(30) Foreign Application Priority Data
Aug. 4, 2022 (CN) 202210932964.4

(51) Int. Cl. A62B 25/00; A45F 3/10; A45F 3/14; A62B 7/02; A62B 9/04

(52) U.S. Cl. CPC A62B 25/00; A45F 3/10; A62B 7/02; A62B 9/04; A45F 2003/146

(57) ABSTRACT

A lumbar adjustment system for use in a self-contained breathing apparatus, the lumbar adjustment system having a rotating ring member operatively connecting a backplate to a lumbar plate, wherein the rotating ring member directly or indirectly engages with a locking notch and grooves in the backplate channel to allow adjustment of the lumbar plate relative to the backplate while the self-contained breathing apparatus is worn by a user.

### CROSS-REFERENCE TO RELATED APPLICATION

This application claims the benefit of priority to Chinese Patent Application No. 202210932964.4, filed Aug. 4, 2022, which is hereby incorporated by reference in its entirety for all purposes.

### 1. FIELD

The invention relates to a backpack and, more particularly, to a lumbar support that may be used on a backpack wherein the lumbar support may be indexed to different positions including when being worn by a user.

### 2. BACKGROUND

A self-contained breathing apparatus (“SCBA”) is a device used to enable breathing in environments which are immediately dangerous to life and health (sometimes referred to as “IDLH” environments). For example, firefighters wear an SCBA when fighting a fire. The SCBA typically has a harness or carrier system including a backplate supporting an air tank which is connected to a facepiece, all of which are worn or carried by the user. The tank typically contains air or oxygen-containing breathing gas under high pressure (for example, 2,200 to 5,500 psi or 15,168 to 37,921 kPa). The SCBA can weigh anywhere from 20 lbs. to 40 lbs. depending on how much air is in the tank and the specific materials used to construct the SCBA.

### 3. SUMMARY

In one aspect, the present disclosure provides a SCBA comprising:
a backplate having a channel defined by two longitudinal edges, each longitudinal edge comprising a plurality of backplate grooves;
a lumbar plate; and
a lumbar adjustment system having a rotating ring member operatively connected to the lumbar plate;
wherein the rotating ring member is directly or indirectly reversibly engaged with the plurality of backplate grooves,
wherein rotation of the rotating ring member about a rotational axis effects disengagement of the rotating ring member with the backplate grooves,
wherein exertion of a linear force on the rotating ring member in an upward or downward direction along the channel effects movement of the lumbar plate in the same direction as the linear force.

Advantageously, the lumbar adjustment system may be operated to adjust the position of the lumbar plate while being worn by a user.

In another aspect, the present disclosure provides a method of assembling a lumbar adjustment system for adjusting a position of a lumbar plate of a SCBA, the method comprising:
connecting a rotating ring member with a lumbar plate; and
mounting the rotating ring member in a channel having two longitudinal edges of a backplate of an SCBA such that
   the rotating ring member is engaged with a plurality of backplate grooves positioned along each of the two longitudinal edges of the backplate;
   rotation of the rotating ring member about a rotational axis effects disengagement of the rotating ring member with the backplate grooves; and
   exertion of a linear force on the rotating ring member in an upward or downward direction along the channel effects movement of a lumbar support connected thereto in the same direction as the linear force.

### 4. BRIEF DESCRIPTION OF THE DRAWINGS

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

FIG. 1 illustrates a self-contained breathing apparatus (SCBA) with a backpack and lumbar support.

FIG. 2 illustrates a SCBA backpack comprising a lumbar adjustment system.

FIG. 3 is an embodiment of a lumbar adjustment system wherein a rotating ring member engages with a plurality of backplate grooves in a channel.

FIG. 4 is an embodiment of a lumbar adjustment system wherein a rotating ring member engages with a locking notch situated between two backplate grooves in a channel of a backplate.

FIG. 5 is a backplate comprising an embodiment of a lumbar adjustment system, wherein a rotating ring member engages with meshing teeth which, in turn, engage with a plurality of backplate grooves in a channel to allow adjustment of the backplate with respect to a lumbar plate.

FIG. 6 is a backplate comprising an embodiment of a lumbar adjustment system that utilizes a spring to create tension between meshing teeth to secure the backplate in a desired position.

FIG. 7 is a backplate comprising an embodiment of a lumbar adjustment system wherein the rotating ring member, meshing teeth, and spring(s) are contained within a swivel support.

FIG. 8 is an exploded side view of the embodiment of the lumbar adjustment system shown in FIG. 7.

FIG. 9 is a condensed view of the embodiment of the lumbar adjustment system shown in FIG. 7 and FIG. 8.

FIG. 10 is an exploded side view of the embodiment of the lumbar adjustment system shown in FIG. 8, shown at a different angle.

FIGS. 11A-D depict the various positions of an embodiment of the lumbar adjustment system relative to the channel of the backplate during adjustment thereof.

FIG. 12 illustrates a side view of an embodiment of the lumbar adjustment system illustrating how the drawbar retains the pad to the swivel support.

FIG. 13 illustrates a side view of an embodiment of the lumbar adjustment system illustrating how the drawbar retains the pad to the swivel support.

FIG. 14 provides a flow diagram of how a lumbar adjustment system as described herein may be assembled.

### 5. DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an,” and “the” include plural references unless the context clearly dictates otherwise. Thus, for example, reference to “a light source” includes a plurality of such light sources and equivalents thereof known to those skilled in the art, and so forth, and reference to “the light source” is a reference to one or more such light sources and equivalents thereof known to those skilled in the art, and so forth.

For purposes of the description hereinafter, the terms “end”, “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

In high-physical demand environments, ill-fitting equipment may introduce significant health and safety issues. Improperly adjusted equipment can provide general wear and tear on a user, increasing their risk of injury and decreasing their availability to provide services. In addition to long term chronic issues, incorrectly positioned equipment can increase the likelihood of serious acute injuries, including entrapments in hazardous environments. A harness system and any equipment associated therewith (for example, a backplate and air tank of an SCBA worn by a firefighter) are typically heavy and are often bulky and difficult to maneuver. Backpacks that require a user to take the equipment off to perform adjustments are suboptimal. Certain systems and methods herein may provide the ability to adjust a backpack's positioning (e.g., a lumbar support) relatively quickly and without taking off their equipment to adjust the position of the SCBA to maximize comfort. This may reduce both chronic and acute injury risk. Further, it may enable a wearer to adjust positioning based on the current needs of the operating environment (e.g., a first SCBA position may be desirable during fast movement such as running, while a second SCBA position may be preferable to a user when in a stationary position).

In one aspect, the present disclosure provides a backplate comprising a lumbar adjustment system, which may be used as part of a self-contained breathing apparatus or SCBA backpack, which is a system used to enable breathing in environments which are immediately dangerous to life and health (IDLH). For example, firefighters may wear an SCBA backpack comprising a backplate with a lumbar adjustment system as described herein when fighting a fire.

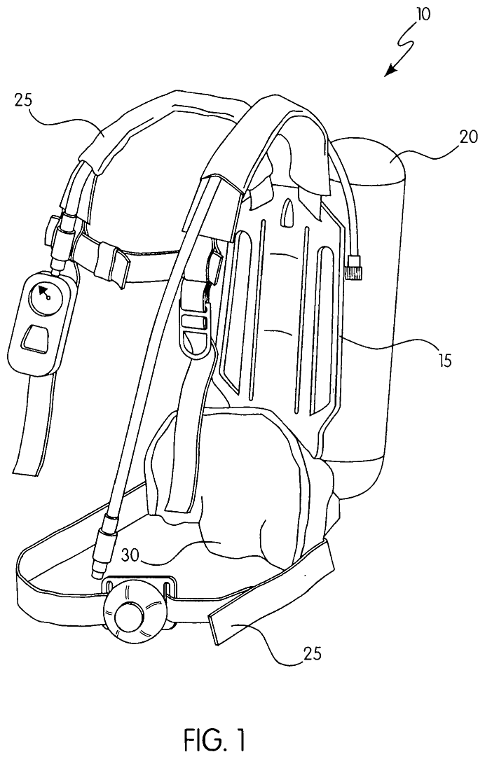

One example of a SCBA is shown in FIG. 1, which may include a harness or harness system 25, a backplate 15, a lumbar support 30, a lumbar adjustment system (not visible from shown angle) and is configured to hold and secure a tank 20, which may contain air or other oxygen-containing gas under high pressure. As use herein, the term “backplate” refers to a relatively rigid support member to which an item such as an air tank of an SCBA may be attached. In any embodiment, a harness system of a SCBA or backplate thereof may include straps intended to be worn over one or more of a user's shoulders. Additionally, the harness system 25 may include straps intended to be worn around a user's waist, for example, to help secure the SCBA close to the user's body. For example, a harness system intended to be worn around a user's waist may be connected to the lumbar support 30.

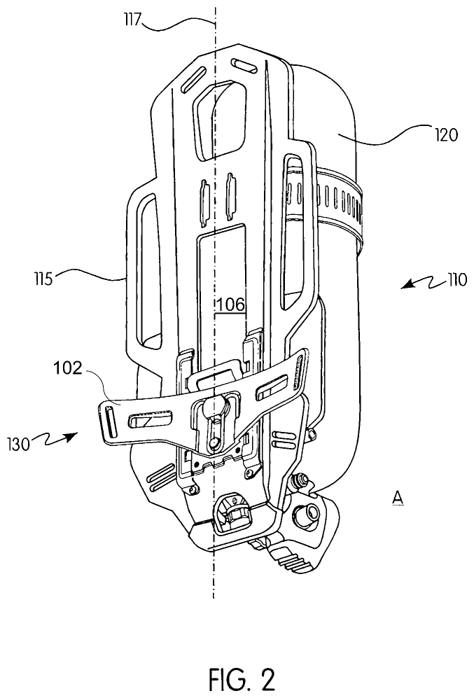

FIG. 2 depicts one example of a SCBA backpack comprising a backplate 115 holding a tank 120. A lumbar plate 102 may be adjusted along a vertical axis 117 of a channel 106 of the backplate 115, which is intended to be worn around a user's waist or lumbar portion of the back, and the backplate is adjustable in vertical direction relative to the user when the user is standing upright via a lumbar adjustment system 130. Advantageously, the adjustable backplate is configured such that the user does not need to take the SCBA off to adjust it. Rather, the lumbar plate 102 may be adjusted relative to the backplate 115 by a user while being worn by the user. Additionally, the instant adjustable backplate 115 may be configured to any one of four or more (e.g., 4, 5, 6, 7, 8, 9, 10, 12, 15, etc.) positions along the vertical direction.

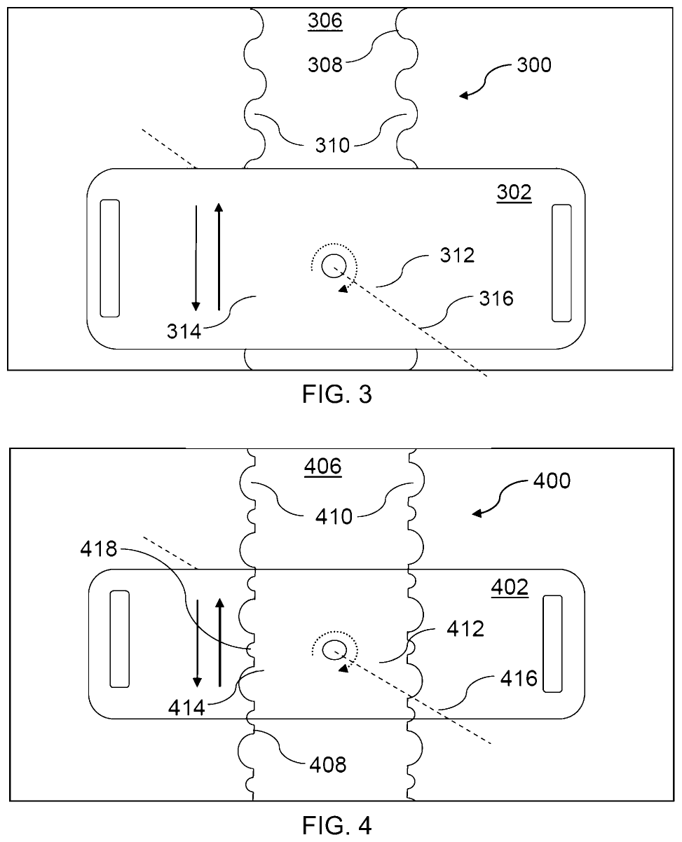

FIG. 3 depicts one embodiment of a lumbar adjustment system 300 that may be used to adjust a backplate according to the instant disclosure. The lumbar adjustment system 300 comprises a channel 306 defined by two longitudinal edges wherein each longitudinal edge 308 comprises a plurality of backplate grooves 310. A lumbar plate 302 is coupled to a rotating ring member 312 which may be directly or indirectly reversibly engaged with the plurality of backplate grooves 310. For example, in FIG. 3, the rotating ring member 312 has two protrusions 314 which engage with the backplate grooves 310. Upon rotating the rotating ring member 312 about a rotational axis (316, see, e.g., dotted circular arrow), the rotating ring member 312 may become disengaged with the plurality of backplate grooves 310. While the dotted arrow in FIG. 3 is depicted as being in the clockwise direction, the rotating ring member 312 may also be rotated in a counterclockwise direction to disengage with the plurality of backplate grooves 310. Applying a linear force (see, e.g., straight arrows) on the rotating ring member 312 by the user in a vertical direction along the channel 306 may allow movement of the lumbar plate 302 in the vertical direction along the channel 306. Once a desired position is achieved, the rotating ring member 312 may be rotated in an opposite rotational direction to re-engage the rotating ring member 312 with the plurality of backplate grooves 310, securing the rotating ring member 312 and lumbar plate 302 connected thereto in the desired vertical position that is comfortable to the user.

In any embodiment, the channel may occupy a lower portion of a backplate and, in any embodiment, may be a separate piece or integral to the backplate. In some embodiments, the channel is integral to the backplate. The number of backplate grooves along each longitudinal edge of the channel is not limited in number, and in some embodiments, each longitudinal edge of the channel comprises four (4) to twenty (20) or more backplate grooves, including, but not limited to, four (4), five (5), six (6), seven (7), eight (8), nine (9), ten (10), twelve (12), fifteen (15), eighteen (18), twenty (20) or more backplate grooves, such as up to fifty (50) backplate grooves. The size and shape of each backplate groove is not particularly limited but should be designed to allow engagement directly or indirectly with a ring protrusion of a rotating ring member. The size and shape of the rotating ring member is not particularly limited and, while depicted as generally circular, may be any shape provided functionality is not lost. For example, a rotating ring member may be oval or a polygon. In any embodiment, the rotating ring member may be coupled directly or indirectly to the lumbar plate and may be integral to or a separate element form the lumbar plate. In some embodiments, the rotating ring member is coupled directly to and is integral to the lumbar plate.

The lumbar plate is not particularly limited in size and shape and should have a length (defined as the dimension which is perpendicular to the vertical direction in which it may be adjusted according to the instant disclosure), that, when a user rotates the lumbar plate about the rotational axis on which it is mounted, exerts sufficient torque on the rotating ring member coupled thereto to effect disengagement of the protrusion of the rotating ring member from the one or more grooves and subsequently allow rotation of the rotating ring member. A lumbar plate may, in any embodiment, comprise elements on its outer edges to facilitate grip by a user, such as a void to create a handle, textured elements, or the like. A lumbar plate may optionally additionally, as described above, further comprise one or more elements of a harness system for aiding in securing the SCBA to a user's waist. A lumbar plate may additional and optionally comprise additional elements that increase comfort to the user, such as padding, contoured parts, and the like.

FIG. 4 depicts another embodiment of a lumbar adjustment system 400. In FIG. 4, ring protrusions 414 of the rotating ring member 412 are reversibly engaged with a locking notch 418. Upon rotating the rotating ring member 412 about a rotational axis (416, see, e.g., dotted circular arrow), the rotating ring member 412 may become disengaged with the locking notch 418 and enters one of the pluralities of backplate grooves 410 either above or below the locking notch 418, thereby releasing tension between the rotating ring member 412 and the longitudinal edges 408 of the channel 406, allowing movement of the lumbar plate 402 along a vertical direction of the channel 406. While the dotted arrow in FIG. 4 is depicted as being in the clockwise direction, the rotating ring member 412 may also be rotated in a counterclockwise direction to disengage with the locking notch 418.

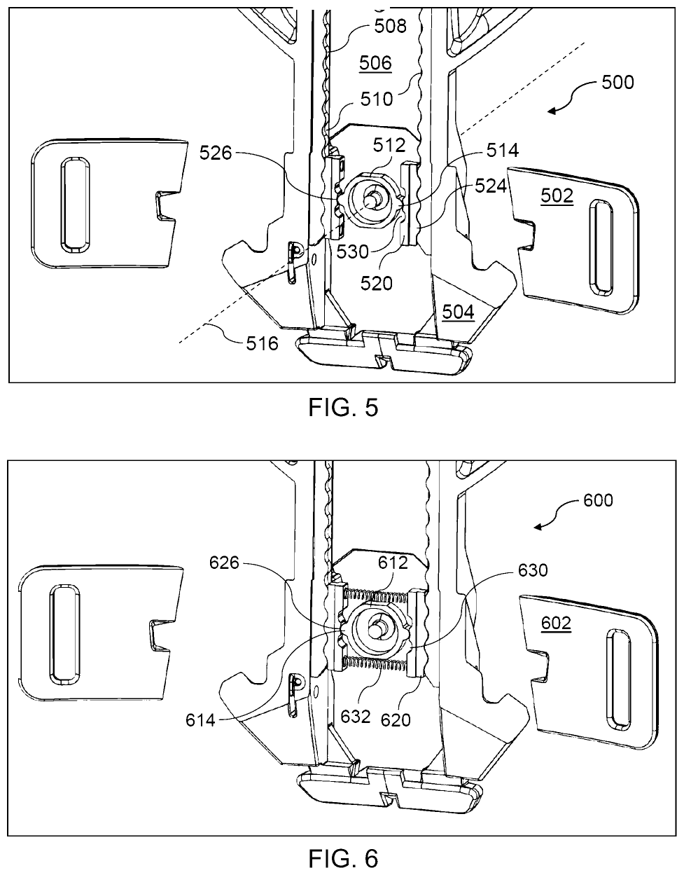

FIG. 5 shows a backplate 504 (e.g., of a SCBA) comprising another embodiment of a lumbar adjustment system 500. The channel 506 of the lumbar adjustment system 500 shown in FIG. 5 is integral to the backplate 504 and defined by two longitudinal edges wherein each longitudinal edge 508 comprises a plurality of backplate grooves 510. A lumbar plate 502 (only outer portions of the lumbar plate are shown to allow depiction of contents behind) is connected to a rotating ring member 512 which is indirectly reversibly engaged with the plurality of backplate grooves 510 on each longitudinal edge 508 via a meshing tooth 520. The ring protrusions 514 are reversibly engaged with a locking notch 526 on each meshing tooth 520. The meshing tooth 520, in turn, is reversibly engaged with the plurality of backplate grooves 510 via a plurality of groove-facing teeth 524. This arrangement secures each meshing tooth 520 between the rotating ring member 512 and plurality of backplate grooves 510 and therefore secures the rotating ring member 512 and lumbar plate 502 connected thereto in a desired vertical position along the channel 506 of the backplate 504. Each meshing tooth 520 may comprises a ring-facing depression 530 above and below the locking notch 526, into which each ring protrusion 514 may move upon rotation of the rotating ring member 512 about the rotational axis 516 on which it is mounted.

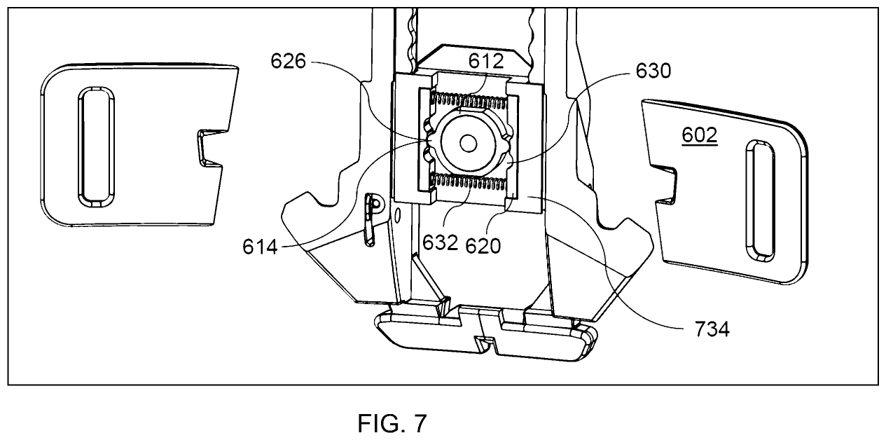

Optionally, a lumbar adjustment system may further comprise at least one spring to exert a tension upon each meshing tooth to maintain its contact with the longitudinal edge of the channel of the backplate. One embodiment of a lumbar adjustment system 600 comprising two springs 632 is shown in FIG. 6. Movement of the ring protrusions 614 towards one of the ring-facing depressions 630 above and below the locking notch 626 releases tension between the rotating ring member 612, the meshing tooth 620, and the longitudinal edges 608 of the channel 606, allowing movement of the lumbar plate 602 and rotating ring member 612 along a vertical direction in the channel 606. In any embodiment, the combined assembly of the meshing teeth 620 and spring(s) 632 may be secured by a swivel support 734, shown in FIG. 7, where like numbers represent the same element as described in FIG. 6.

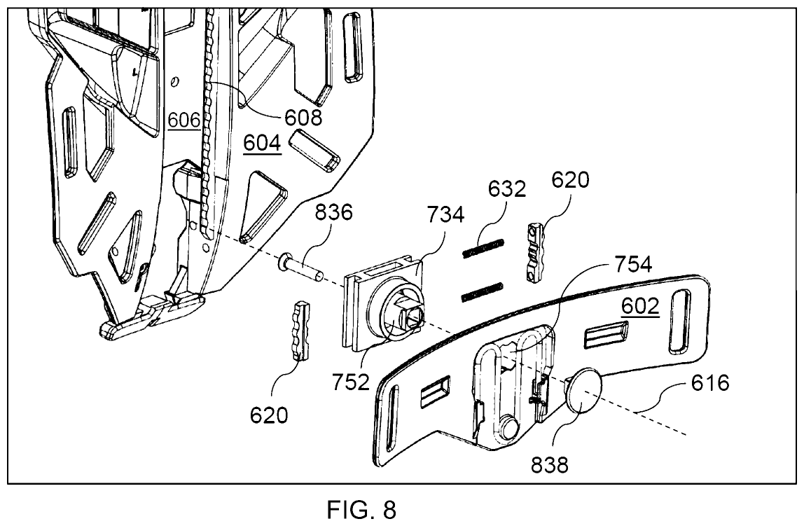

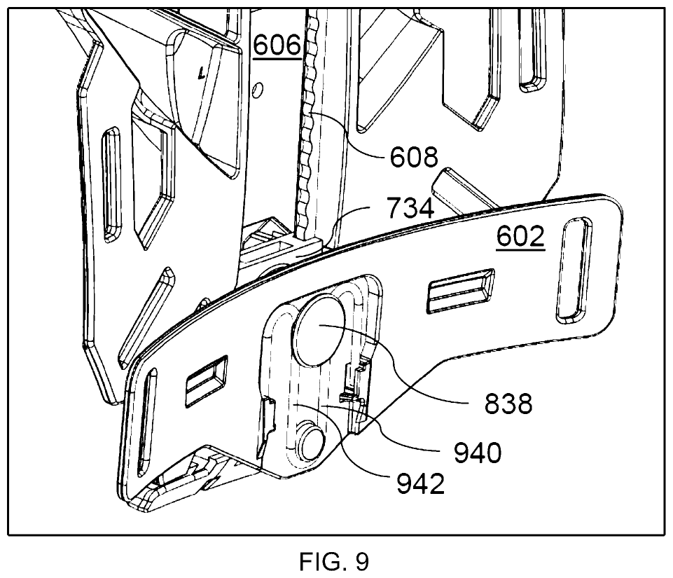

An exploded side view of the embodiment of the lumbar adjustment system shown in FIG. 7 can be seen in FIG. 8, where like numbers represent the same element as described in FIG. 7. A screw 836 and nut 838 mount and secure the lumbar plate 602 and rotating ring member (not shown from this angle) to the swivel support 734, spring(s) 632, and meshing teeth 620 along the rotational axis 616 through engagement of a non-circular projection 752 of the swivel support 734 through a non-circular opening 754 in the lumbar plate 602. The lumbar plate 602 is attached to the user-facing side of the backplate 604. A collapsed view of the embodiment shown in FIG. 8 is shown in FIG. 9, where like numbers represent the same element as described in FIG. 7 and FIG. 8. A drawbar 940 may be included to aid in the adjustment process, which will be described in further detail below.

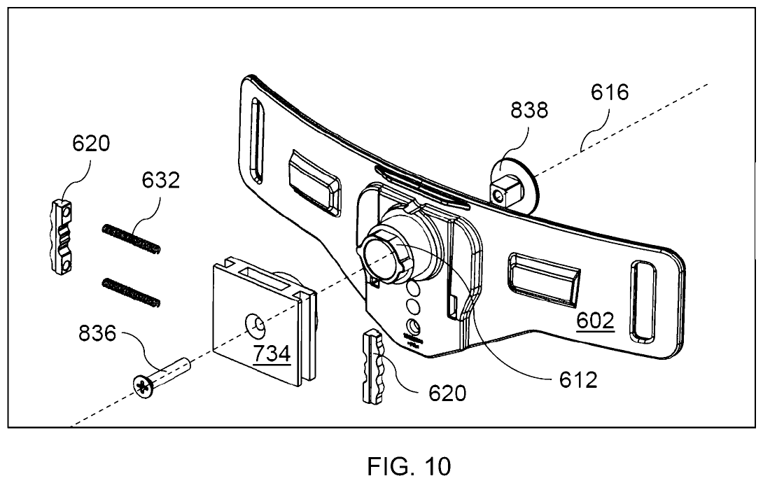

FIG. 10 depicts an exploded side view of the same embodiment of the lumbar adjustment system shown in FIG. 8, where like numbers represent the same element as described in FIG. 6, but from a different angle and without depicting the backplate. In FIG. 10, the rotating ring member 612 is integral with the lumbar plate 602.

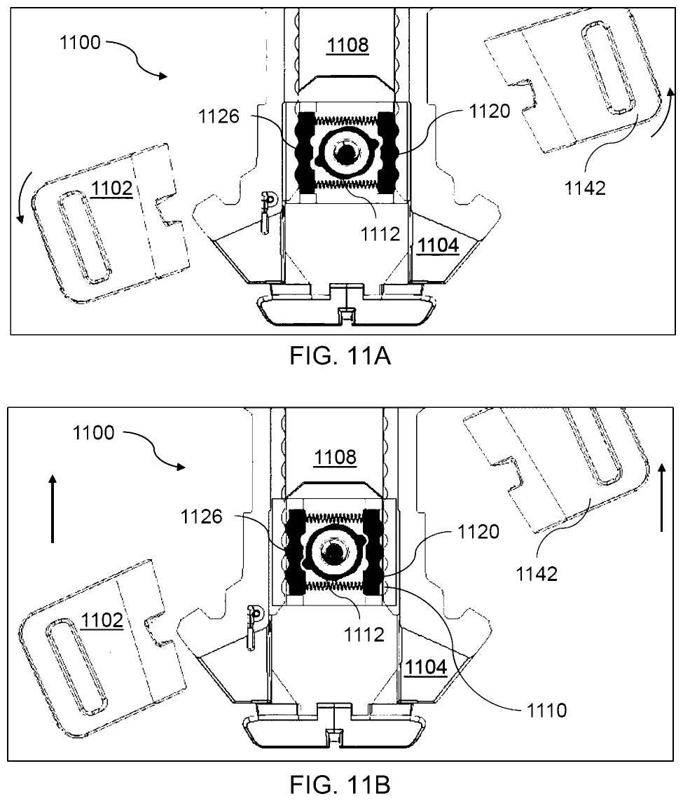

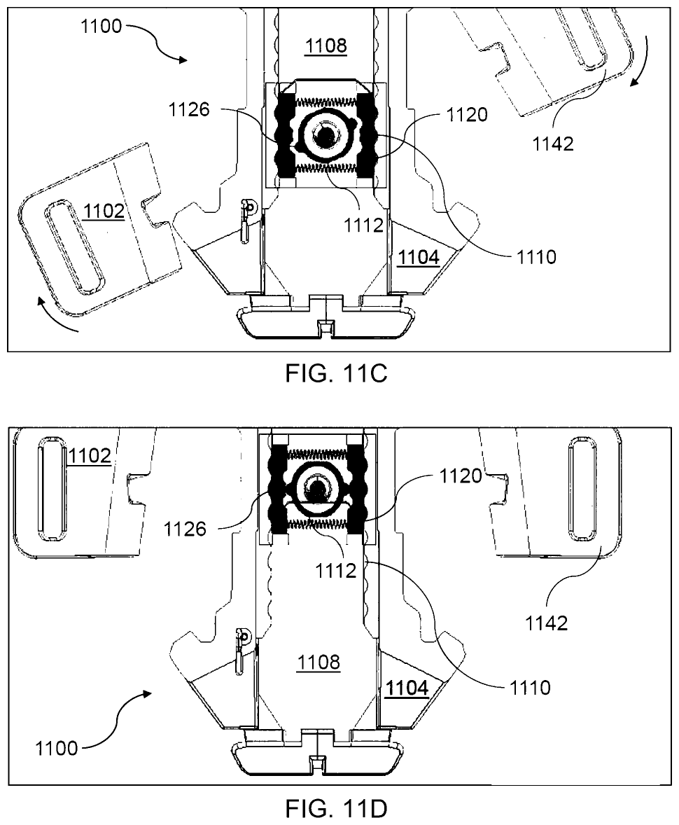

FIG. 11A-D depicts movement of the various parts of one embodiment of a lumbar adjustment system 1100 during adjustment of a lumbar plate 1102 with respect to a vertical direction along a channel 1108 of a backplate 1104. As shown in FIG. 11A, the rotating ring member 1112 may be rotated about a rotational axis by applying a rotational force to the lumbar plate 1102 (see, e.g., curved arrows), for example, an outer portion 1142 of the lumbar plate. While the curved arrows are depicted in the clockwise direction in FIG. 11A, rotational force may also be applied in a counterclockwise direction. The rotating ring member 1112 may become disengaged with the locking notch 1126 of the meshing tooth 1120, providing room for the meshing tooth 1120 to disengage with the plurality of backplate grooves 1110 as shown in FIG. 11B. In FIG. 11B, applying a linear force (see, e.g., linear arrows) on the lumbar plate 1102 by the user in a vertical direction may effect movement of the lumbar plate 1102 in the vertical direction. In FIG. 11C, a desired position is achieved by continuing to move the lumbar plate in the vertical direction, where the rotating ring member 1112 re-engages with the locking notch 1126 of the meshing tooth 1120. Thereafter, the user may rotate the lumbar plate 1102 in an opposite rotational direction (see, e.g., curved arrows in FIG. 11C) to re-engage the rotating ring member 1112 with each meshing tooth 1120, locking the rotating ring member 1112 and lumbar plate 1102 connected thereto in the desired vertical position, as shown in FIG. 11D. Alternatively, a drawbar, such as that shown in FIG. 9 (but which is not depicted in FIG. 11), may be included, which will automatically rotate the lumbar plate back to its original position.

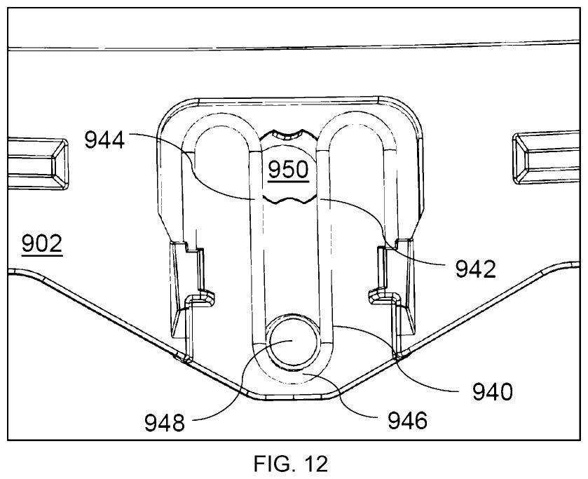

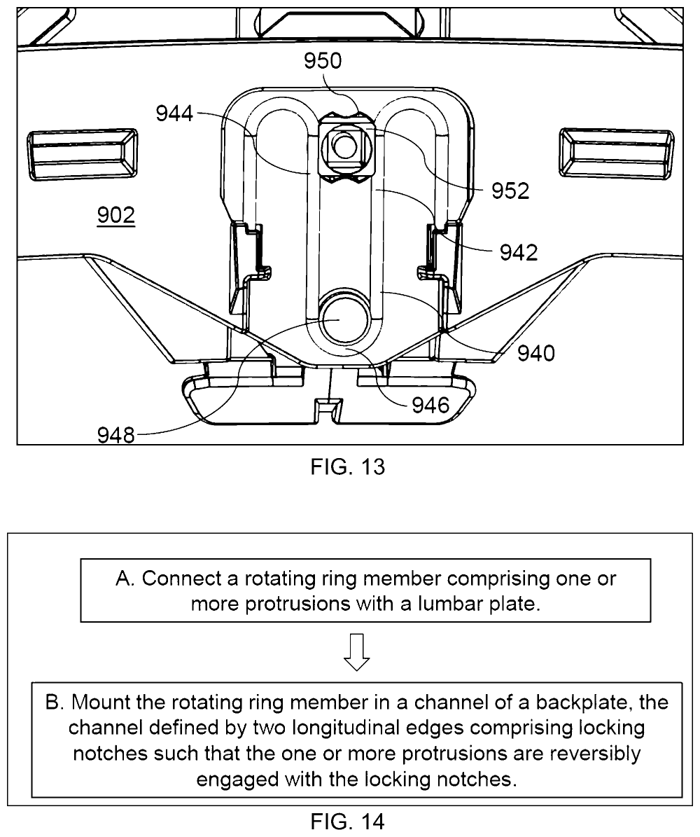

In FIG. 12, the drawbar 940 is substantially in the shape of a “U”, having two extending primary legs 942, 944 connected by a transition portion 946. The lumbar plate 902 further includes a locating pin 948 spaced from the non-circular opening 950 such that the transition portion 946 contacts the locating pin 948 and the extending primary legs 942, 944 engage and straddle the non-circular opening 950 of the lumbar plate 902 and non-circular projection of the swivel support (not shown). As a result, rotation of the lumbar plate 902 relative to the swivel support and backplate (not shown) is resiliently resisted when the two legs 942, 944 are spread apart, resulting in a self-centering arrangement. FIG. 13 illustrates the same embodiment as FIG. 12 (where like numbers represent like elements) but depicts the non-circular projection of the swivel support 952 engaged with the non-circular opening 950 of the lumbar plate 902.

The lumbar adjustment system disclosed herein enables adjustment of a lumbar support relative to the vertical direction of a backplate of a SCBA worn by a standing user without taking the SCBA and backplate off. For example, a user can wear a SCBA mounted on a backplate on their back, with the lumbar plate positioned on the bottom portion of the backplate, adjacent to the user's lumbar area. The user may reach back to grip an outer portion of the lumbar plate and exert a rotational force to disengage the rotating ring member with the plurality of backplate grooves, which may, for example, occur indirectly via a meshing tooth, then exert a linear force to adjust the position of the lumbar plate along the vertical direction along the channel of the backplate. Once the lumbar plate is in the desired position, the user may then apply an opposite rotational force to the lumbar plate to reengage the rotating ring member with the plurality of backplate grooves (e.g., through a locking notch of meshing teeth). Alternatively, the lumbar adjustment system may comprise a drawbar as described above and simply releasing the lumbar plate by the user will cause the lumbar plate to return to its original horizontal position and cause reengagement of the rotating ring member with the plurality of backplate grooves.

In another aspect, the present invention provides a method of assembling a lumbar adjustment system e.g., of an SCBA, that may be used to adjust the position of a lumbar plate, for example, relative to a user's lumbar area, to enhance the comfort of the user wearing an SCBA with the lumbar adjustment system. In any embodiment, a lumbar adjustment system may be assembled by a method comprising: (a) connecting a rotating ring member with a lumbar plate; and (b) mounting the rotating ring member in a channel defined by two longitudinal edges of a backplate such that (i) the rotating member is engaged with a plurality of backplate grooves positioned along each of the two longitudinal edges of the backplate; (ii) rotation of the rotating ring member about a rotational axis effects disengagement of the rotating ring member with the backplate grooves; and (iii) exertion of a linear force on the rotating ring member in an upward or downward direction along the channel effects movement of a lumbar support connected thereto in the same direction as the linear force. In any embodiment, the rotating ring member may be indirectly engaged with the plurality of backplate grooves, for example, via a meshing tooth. In such embodiments, a ring protrusion of the rotating ring member may be engaged with a ring-facing depression of a meshing tooth, and a plurality of groove-facing teeth may be engaged with the plurality of backplate grooves. FIG. 14 provides a general schematic of the above-described method of assembling a lumbar adjustment system.

1. A self-contained breathing apparatus (SCBA) comprising:
a backplate having a channel defined by two longitudinal edges, each longitudinal edge comprising a plurality of backplate grooves;
a lumbar plate; and
a lumbar adjustment system having a rotating ring member operatively connecting the backplate to the lumbar plate;
wherein the rotating ring member is directly or indirectly reversibly engaged with the plurality of backplate grooves,
wherein rotation of the rotating ring member about a rotational axis effects disengagement of the rotating ring member with the backplate grooves,
wherein exertion of a linear force on the rotating ring member in an upward or downward direction along the channel effects movement of the lumbar plate in the same direction as the linear force.

2. The self-contained breathing apparatus of claim 1, wherein the lumbar adjustment system is configured to adjust the position of the lumbar plate while the SCBA is being worn by a user.

3. The self-contained breathing apparatus of claim 1, wherein rotation of the rotating ring member is effected by applying a rotational force to an outer portion of the lumbar plate and wherein exertion of the linear force is effected by applying the linear force on the lumbar plate.

4. The self-contained breathing apparatus of claim 1, wherein the rotating ring member is indirectly engaged with the plurality of backplate grooves via a meshing tooth.

5. The self-contained breathing apparatus of claim 1, wherein the rotating ring member comprises at least two ring protrusions, each of which are positioned substantially opposite of one another along the perimeter of the rotating ring member, and each of which reversibly engage with a locking notch of each meshing tooth.

6. The self-contained breathing apparatus of claim 5, wherein each meshing tooth comprises a meshing tooth depression above and below the locking notch.

7. The self-contained breathing apparatus of claim 5, wherein each meshing tooth comprises a plurality of groove-facing teeth which are complementary in shape to and reversibly engaged with the plurality of backplate grooves.

8. The self-contained breathing apparatus of claim 6, wherein rotation of the rotating ring member effects movement of each of the at least two rotating ring protrusions towards one of the ring-facing depressions above and below the locking notch, wherein exertion of the linear force effects engagement of each rotating ring protrusion with the ring-facing depression towards which it had moved.

9. The self-contained breathing apparatus of claim 5, further comprising at least one spring, the ends of which contact a ring-facing edge of each meshing tooth, wherein the spring exerts a tension upon each meshing tooth to maintain its contact with the longitudinal edge of the channel of the backplate; wherein movement of each of the rotating ring protrusions towards one of the ring-facing depressions above and below the locking notch releases the tension.

10. The self-contained breathing apparatus of claim 9, wherein the meshing teeth and at least one spring are contained within a swivel support.

11. The self-contained breathing apparatus of claim 10, wherein the swivel support comprises a non-circular projection which engages with a non-circular opening in the lumbar plate.

12. The self-contained breathing apparatus of claim 11, further comprising:
a drawbar having two extending primary legs connected by a transition portion; and
a locating pin spaced from the non-circular opening such that the transition portion of the drawbar contacts the locating pin, and the extending primary legs engage and straddle the non-circular opening of the lumbar plate and non-circular projection of the swivel support.

13. The self-contained breathing apparatus of claim 2, wherein the backplate is configured to support a tank.

14. The self-contained breathing apparatus of claim 2, wherein the lumbar adjustment system is attached to an interior face of the backplate.

15. The self-contained breathing apparatus of claim 1, wherein each longitudinal edge of the channel comprises at least four backplate grooves.

16. The self-contained breathing apparatus of claim 1, further comprising at least one shoulder strap and a waist belt assembly connected directly or indirectly to the backplate.

17. A method of assembling a lumbar adjustment system for adjusting a position of a lumbar plate of a self-contained breathing apparatus (SCBA), the method comprising:
connecting a rotating ring member with a lumbar plate; and
mounting the rotating ring member in a channel having two longitudinal edges of a backplate of an SCBA such that
the rotating ring member is engaged with a plurality of backplate grooves positioned along each of the two longitudinal edges of the backplate;
rotation of the rotating ring member about a rotational axis effects disengagement of the rotating ring member with the backplate grooves; and
exertion of a linear force on the rotating ring member in an upward or downward direction along the channel effects movement of a lumbar support connected thereto in the same direction as the linear force.

18. The method of claim 17, wherein the mounting of the rotating ring member in the channel comprises
engaging a rotating ring protrusion of the rotating ring member with a locking notch on a meshing tooth, and
engaging a plurality of groove-facing teeth with the plurality of backplate grooves on each longitudinal edge of the channel.

19. The lumbar adjustment system of claim 17 or 18, wherein the swivel support comprises a non-circular projection which engages with a non-circular opening in the lumbar plate and wherein the method further comprises coupling to the lumbar adjustment system a drawbar having two extending primary legs connected by a transition portion such that:
the transition portion contacts a locating pin which is spaced from the non-circular opening in the lumbar plate; and
the extending primary legs engage and straddle the non-circular opening of the lumbar plate and non-circular projection of the swivel support.

20. The lumbar adjustment system of claim 17, wherein each longitudinal edge of the channel comprises at least four backplate grooves.
